(19) United States
(12) Patent Application Publication
(10) Pub. No.: US 2003/0154806 A1
(43) Pub. Date: Aug. 21, 2003

(54) Method for determining the rail pressure of an injector vale having an piezoelectrical actuator

(76) Inventor: Johannes-Joerg Rueger, Wien (AT)

Correspondence Address: KENYON & KENYON, ONE BROADWAY, NEW YORK, NY, 10004, US

(21) Appl. No.: 10/239,585

(22) PCT Filed: Jan. 17, 2001
(86) PCT No.: PCT/DE01/00175

(30) Foreign Application Priority Data
Mar. 24, 2000 (DE) 100 14 737.2

(51) Int. Cl. F02M 65/00; G01M 19/00

(52) U.S. Cl. 73/865.9; 73/119 A

(57) ABSTRACT

According to the present invention, a method is proposed for determining the rail pressure of an injector having a voltage-controlled piezoelectrical actuator, the piezoelectrical actuator (2) actuating a nozzle needle (11) using hydraulic coupler (4). As a result of the pressure in the high-pressure channel (13), a coupler pressure (Pₖ) is built up via the hydraulic coupler (4), the coupler pressure inducing a piezovoltage (Uᵢ) in the actuator (2). Because this voltage value is redundant with regard to the pressure value in the high-pressure channel (13), which is measured by a pressure sensor (D), the voltage value can be used for monitoring the functioning of the pressure sensor (D). In the event of the failure of the pressure sensor (D), emergency operation can be built up for the injector (1) with the assistance of the induced voltage (Uᵢ). The injector (1) advantageously functions for injecting fuel in an internal combustion engine.

### BACKGROUND INFORMATION

The present invention relates to a method for determining the rail pressure of an injector having a voltage-controlled piezoelectrical actuator in accordance with the species of the main claim.

It is already known, in an injector having a piezoelectrical actuator, to drive the motion of the nozzle needle not directly but via a hydraulic coupler. One task of the coupler is to reinforce the stroke of a control valve. For correct functioning, however, the hydraulic coupler must be completely charged, especially since in every driving of the piezoelectrical actuator a portion of the fluid is squeezed out of the hydraulic coupler through leakage gaps. In this context, the recharging takes place in the pause between two injections. In order to release a predetermined quantity of fluid in the high-pressure channel, it is necessary to know the pressure in the high-pressure channel. This pressure is usually measured by an appropriate sensor, which is arranged in the high-pressure line system (common rail system) at an appropriate location. In this context, the problem can arise that an erroneous rail pressure measurement can result from the failure of the pressure sensor. Due to the incorrect rail pressure measurement, it is then no longer assured that the predetermined injection quantity will actually be released. This can be critical especially in a motor-vehicle having an internal combustion engine, if the predetermined quantity of fuel is not injected. The result can be abrupt disruptions in functioning and potentially the shutdown of the internal combustion engine. Furthermore, undesirable, large injection quantities can also occur.

### ADVANTAGES OF THE INVENTION

In contrast, the method according to the present invention for determining the rail pressure of an injector having a voltage-controlled piezoelectrical actuator and having the characterizing features of the main claim possesses the advantage that the pressure in the high-pressure channel of the injector is measured by measuring the induced piezovoltage. The result is a redundant pressure measurement, which makes it possible to monitor the measured value of the pressure sensor.

As a result of the measures indicated in the dependent claims, advantageous refinements and improvements of the method cited in the main claim are possible. It is especially advantageous that, using a simple algorithm, for example, in the form of a linear equation or a table, it is possible to reach conclusions regarding the prevailing rail pressure on the basis of the measured piezovoltage. In this way, it is possible to obtain an electrical characteristic quantity that is assigned to the rail pressure and that can easily be further processed by the electronics.

By comparing the calculated rail pressure with the measured value of the pressure sensor, it is possible, in a simple manner, to monitor the normal functioning of the pressure sensor. If the pressure sensor fails, for example, as a result of a line break or a fault, then the redundant measured value can be retrieved for emergency operation in maintaining the functioning of the internal combustion engine.

In the case of a fault, it is advantageous to store the measured voltage values or the pressure value, so that the event can be reconstructed at a later time point. This is especially important for an internal combustion engine that has a common rail injection system, to assure operating reliability.

### DRAWING

An exemplary embodiment of the present invention is depicted in the drawing and is discussed in greater detail in the description below.

FIG. 1 depicts a schematic representation of an injector having a piezoelectrical actuator.

FIG. 2 depicts an allocation diagram.

FIG. 3 depicts a voltage diagram.

FIG. 4 depicts a block diagram.

### DESCRIPTION

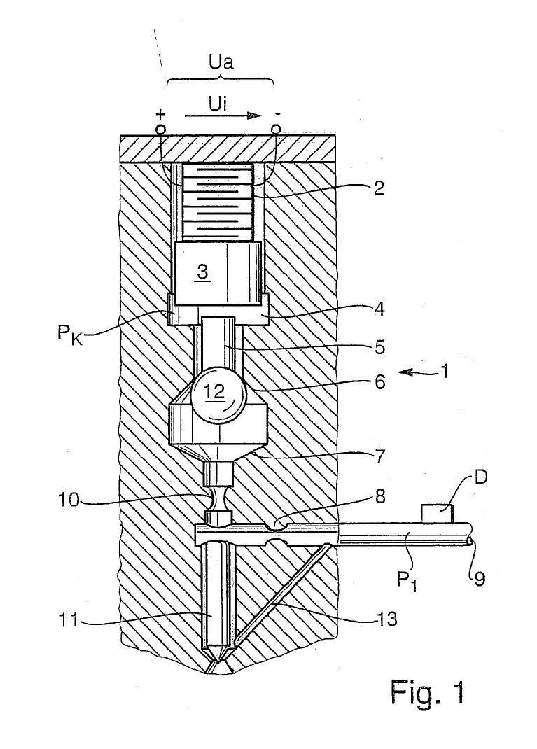

FIG. 1, in a schematic representation, shows an injector 1 having a central bore. In the upper part of the bore, a piezoelectrical actuator 2 is introduced, at whose lower end an operating piston 3 is mounted. Operating piston 3 stops a hydraulic coupler 4 towards the top, the coupler having an opening towards the bottom having a connecting channel to a first seat and a control valve 5 having a sealing member 12 being arranged in the coupler. In this context, sealing member 12 is configured so that it seals first seat 6, if actuator 2 is in the resting phase, i.e., if no drive voltage Uₐ is applied to it. When actuator 2 is actuated by the application of drive voltage Uₐ at clamps +, −, actuator 2 actuates operating piston 3 and, via hydraulic coupler 4, pushes control valve 5 having sealing member 12 in the direction of second seat 7. Arranged below second seat 7 in a corresponding channel is a nozzle needle 11, which closes or opens the outlet for high-pressure channel 13, for example, a common rail system, depending on the level of drive voltage Uₐ and pressure P₁ that are applied in the high-pressure area. The high pressure is conveyed via a supply line 9 by the medium to be injected, for example, fuel for an internal combustion engine. Via a supply-line throttle 8 and an outlet throttle 10, the inflow quantity of the medium is controlled in the direction of nozzle needle 11 and hydraulic coupler 4. In this context, hydraulic coupler 4 is designed, on the one hand, to intensify the stroke of piston 5 and, on the other hand, to decouple control valve 5 from the static temperature expansion of actuator 2.

The dimensioning of hydraulic coupler 4 is such that the latter is refilled by a pressure derived from the rail pressure, specifically when sealing member 12 is positioned on first seat 6. This can be realized, for example, as a constant transmission ratio. If this transmission ratio is, for example, 1:10, then the pressure in hydraulic coupler 4 is only 1/10 of the rail pressure.

In what follows, the mode of functioning of injector 1 is discussed in greater detail. In response to each driving of actuator 2, operating piston 3 moves in the direction of hydraulic coupler 4. In this context, control valve 5 having sealing member 12 also moves in the direction of second seat 7. In this context, a portion of the medium in hydraulic coupler 4, for example, the fuel, is squeezed out through a leakage gap. Thus, between two injections, hydraulic coupler 4 must be refilled, to maintain its functional reliability. A coupler 4 that is empty or only partially filled has the effect that nozzle needle 11 cannot release high-pressure channel 13 for the injection of the preestablished quantity of fluid, so that injection misfires can arise.

As was already mentioned, a high pressure predominates in supply line channel 9 amounting, in the common rail system, for example, to between 200 and 1600 bar. This pressure pushes against nozzle needle 11 and holds it closed against the pressure of an undepicted spring, so that no fuel can escape. If, as a consequence of drive voltage Uₐ, actuator 2 is actuated and therefore sealing member 12 moves in the direction of the second seat, then the pressure in the high-pressure area declines and nozzle needle 11 releases the injection channel. After drive voltage Uₐ is withdrawn, hydraulic coupler 4 is once again refilled.

For the injection of fuel into an internal combustion engine, especially in direct injection, the fuel quantity to be injected must be determined as a function of the engine conditions and driving conditions of the vehicle. Determining the injection quantity must be accomplished as precisely as possible for each actuation of nozzle needle 11, in order to achieve an optimal combustion in the cylinder of the internal combustion engine with respect to exhaust gas emission requirements, fuel economy, and performance spectrum. Therefore, the instantaneous pressure is usually measured using a pressure sensor that is arranged at an appropriate location in the high-pressure system of the common rail lines, and the instantaneous pressure is made available to an appropriate control unit as a measured value. Because this pressure sensor must operate very reliably, the present invention provides that a further pressure measurement be carried out, which is redundant with respect to the measurement of the pressure sensor. This second pressure measurement is carried out using the piezovoltage that is induced in piezoelectrical actuator 2, the piezovoltage arising as a result of the pressure in hydraulic coupler 4 and being measurable at actuator 2. On account of the fact that the coupler pressure, assuming complete charging, is a function of the rail pressure, the instantaneous rail pressure can be derived from the induced voltage. In this context, this induced voltage Uᵢ functions as a further (redundant) measuring signal for the pressure prevailing in high-pressure channel 13. For the pressure measurement, the control unit now receives two measured values, which make it possible, on the one hand, to monitor the measuring signal of the pressure sensor. On the other hand, in the event of the failure of the pressure sensor, induced voltage Uᵢ can be used to assure emergency operation of the internal combustion engine.

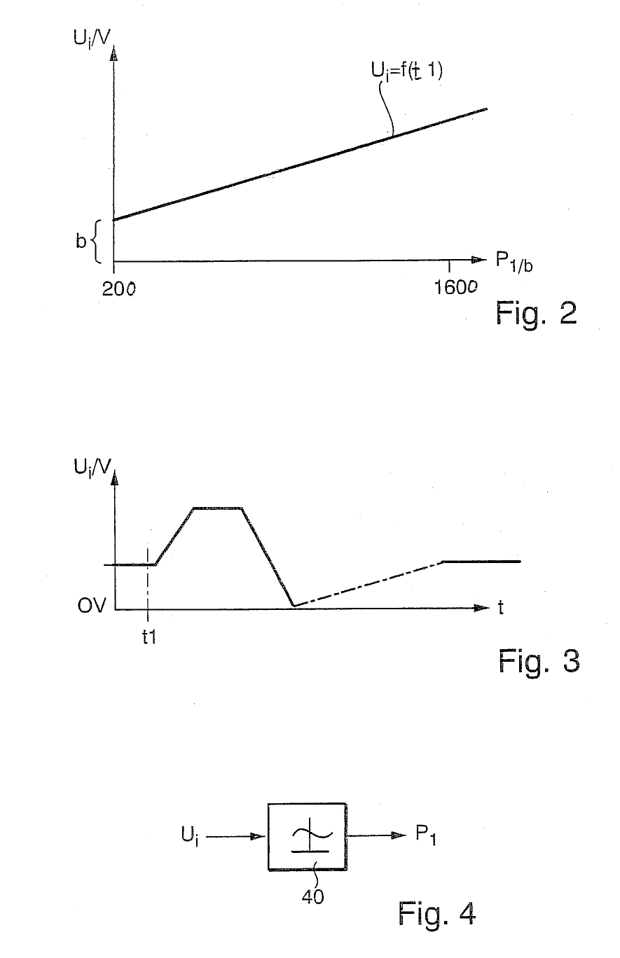

FIG. 2 depicts an allocation diagram, in which voltage Uᵢ, induced in actuator 2, is plotted on the y-axis and pressure P₁, measured by pressure sensor D for the high-pressure line system, is plotted on the x-axis. The curve Uᵢ=f(P₁,) indicates the relationship between the two cited variables. Depicted is a linear equation

P₁=a*Uᵢ+b,

a being the slope as a proportionality factor and b being an offset value. This curve can be used as an algorithm, alternatively to a table, which is advantageously determined empirically.

FIG. 3 depicts a segment of a typical voltage diagram in which voltage Uᵢ, applied at actuator clamps +, −, is plotted as a function of time. Initially, coupler 4 is filled by time point t₁, and the measured voltage corresponds to voltage Uᵢ that is induced by the coupler pressure.

After time point t₁, a driving occurs, in which the actuator is initially charged and, at a later time point, is once again completely discharged. In this context, coupler 4 is also emptied accordingly. However, due to the coupler pressure, a voltage Uᵢ is induced. The latter rises at a given gradient, because in this time period coupler 4 is once again filled, until it has reached its setpoint filling, i.e., until the static coupler pressure is built up.

To determine the high pressure, it seems advantageous to measure induced voltage Uᵢ at time point t₁. Derived from this measured value, in accordance with the aforementioned algorithm, is corresponding high-pressure P₁, which is compared to the measured value of pressure sensor D. In event of a deviation between measured high-pressure P₁ and comparison value Uᵢ beyond a preestablished threshold value, a check is carried out as to whether a fault exists in the high-pressure system itself, or whether there is a fault in pressure sensor D. In the event of a fault in pressure sensor D, it is provided to use the pressure value from induced voltage Uᵢ for generating drive voltage Uₐ . Using this redundant measurement, it is therefore possible to maintain emergency operation for the fuel injection in an internal combustion engine.

FIG. 4 depicts a block diagram for generating the pressure value from piezovoltage Uᵢ, measured at time point t₁. The algorithm for the conversion is stored in a transformation unit 40. This algorithm can contain the function P₁=f(Uᵢ(t₁)) according to FIG. 2 or an appropriate table. The output signal for pressure P₁ then functions as a plausibility check for the measured rail pressure, or as a replacement value for the rail pressure in the event of a fault.

What is claimed is:

1. A method for determining the rail pressure (P₁) of an injector (1), having a voltage-controlled piezoelectrical actuator (2), the piezoelectrical actuator (2) actuating a nozzle needle (11) using a hydraulic coupler (4), in order to release a quantity of fluid that is acted upon by the rail pressure (P₁) in a high-pressure channel (13), wherein the rail pressure (P₁) acts upon the piezoelectrical actuator (2) via the hydraulic coupler (4) and generates a piezovoltage (Uᵢ) in the actuator (2), and the rail pressure (P₁) is calculated from the piezovoltage (Uᵢ) using a preestablished algorithm.

2. The method as recited in claim 1, wherein the calculated rail pressure is basically determined in accordance with the linear equation
P₁=a* Uᵢ+b,
a being a proportionality factor and b being an offset value.

3. The method as recited in claim 1 or 2, wherein the comparison values are stored in a table.

4. The method as recited in one of the preceding claims, wherein the piezovoltage (Uᵢ) is measured, in temporal terms, immediately before the subsequent charging operation of the coupler (4).

5. The method as recited in one of the preceding claims, wherein a pressure sensor (D) is provided, which is positioned at an appropriate location in the high-pressure system, and the measured rail pressure is compared to the calculated rail pressure.

6. The method as recited in claim 5, wherein, in the event that the difference between the pressure values exceeds or falls below a preestablished threshold value, a fault message is generated.

7. The method as recited in claim 5 or 6, wherein the fault message is stored.

8. The method as recited in one of the preceding claims, wherein the injector is used for injecting fuel into a common rail system of an internal combustion engine.

9. The method as recited in one of claims 5 through 8, wherein, when a preestablished threshold value is exceeded, an emergency-operation function is recognized.
